(19) United States
(12) Patent Application Publication
(10) Pub. No.: US 2026/0296458 A1
(43) Pub. Date: Oct. 1, 2026

(54) Computer-Implemented Method and System for Behavior Planning and Training Methods for Such a System

(71) Applicant: Robert Bosch GmbH, Stuttgart (DE)

(72) Inventors: Juergen Mathes, Stuttgart-Moehringen (DE); Luca Paparusso, Stuttgart (DE); Lutz Buerkle, Stuttgart (DE); Markus Mazzola, Tuebingen (DE); Maxim Dolgov, Renningen (DE); Nicolas Moeser, Renningen (DE); Oliver Scheel, Stuttgart (DE); Philipp Geiger, Karlsruhe (DE); Yakov Miron, Tuebingen (DE); Yu Yao, Herzogenrath (DE)

(21) Appl. No.: 19/576,340

(22) Filed: Mar. 24, 2026

(30) Foreign Application Priority Data
Mar. 25, 2025 (DE) 10 2025 111 438.2

(51) Int. Cl. B60W 50/00; B60W 60/00; G05B 13/02

(52) U.S. Cl. CPC B60W 50/0098; B60W 60/001; G05B 13/0265; B60W 2050/0028; B60W 2556/40; B60W 2556/45

(57) ABSTRACT

A method is for behavior planning for an at least partially automated ego vehicle in a traffic scene, in which a current state of the traffic scene is captured and mapped to an initial state in a latent space. The method includes starting from the initial state, a tree structure of a plurality of state sequences in the latent space is generated by generating at least one subsequent state of the tree structure for n successive time steps, each starting from a starting state that the at least one subsequent state of the tree structure is generated. The method also includes determining, for the starting state, a multimodal behavior policy for the ego vehicle and a starting value of the starting state, and selecting a selected behavior option from the multimodal behavior policy and determining a reward for selecting the selecting behavior option in the starting state.

This application claims priority under 35 U.S.C. § 119 to patent application no. DE 10 2025 111 438.2, filed on Mar. 25, 2025 in Germany, the disclosure of which is incorporated herein by reference in its entirety.

### BACKGROUND

The disclosure relates to a computer-implemented method for behavior planning for an at least partially automated ego vehicle in a traffic scene, in which the current state of the traffic scene is captured and mapped to an initial state so in a latent space.

The disclosure further relates to a computer-implemented system for behavior planning for an at least one semi-automated ego vehicle in a traffic scene, wherein the system comprises a perception layer for capturing a current state of a traffic scene, a backbone network for mapping the captured current state to an initial state so in a latent space, and a computing unit configured to perform behavior planning.

Finally, the disclosure relates to a method for training such a system for behavior planning for an at least partially automated ego vehicles.

The starting point for behavior planning is always the state of the traffic scene in which the ego vehicle is located at the time of planning. The state of the traffic scenario is captured by scenario-specific information aggregated from different sources of information at the planning timepoint or also over a certain period of time before and up to this timepoint. The current state of a traffic scene is captured using the perception layer of the system for behavior planning. The information sources can be in-vehicle sensors, such as LiDAR sensors, radar sensors and/or RGB cameras installed on the ego vehicle, or non-vehicle sensors, such as LiDAR sensors, radar sensors, and/or RGB cameras installed in or on infrastructure elements or other traffic participants. Other possible sources of information include stored map information, along with traffic rules if applicable, as well as retrievable weather and road condition information, traffic situation information, etc.

For the behavior planning of the ego vehicle, the current state of the traffic scene must be analyzed. For this, the learned methods, such as machine learning-based (ML) and deep learning-based (DL) methods, have established themselves as a “de facto” standard, since these methods can take into account diverse contextual information without the need to explicitly model the context. To that end, the aggregated scenario-specific information is mapped onto a vector in a latent space using a backbone network. This corresponds to a mapping of the current state of the traffic scene to an initial state so in a latent space. There are a variety of backbone networks that can be used to transform data into the latent space. The choice of the backbone network will depend heavily on the type of data, the desired complexity of the latent space, and the computing resources. By way of example, convolutional neural networks (CNNs) and graph neural networks (GNNs) with autoencoders are mentioned here.

For the behavior planning of autonomous vehicles, learned models are frequently used that are based on imitation learning and behavior cloning. These models attempt to replicate an expert behavior they have learned from training datasets.

It is also known to improve the artificial intelligence (AI)-based methods for behavior planning of autonomous vehicles by a tree search.

Current AI-based methods for behavior planning of autonomous vehicles show one or more of the following weaknesses, particularly under real, noisy conditions. Unimodal planning neglects the fact that multiple behaviors are possible and permitted in many traffic situations. At intersections in particular, borderline situations often arise in which, for example, “remaining stopped” and “starting quickly” represent equally valid behavior options. In the worst case scenario, the learned model will marginalize over the different behavior options and create an intermediate behavior, such as “slow starting.” By purely imitation learning, the model essentially only learns meaningful behavior planning, i.e. expert behavior, for situations that are represented in the training datasets. Typically, such a trained model can generalize this “knowledge” only to a very limited extent, so that it can handle new, unknown situations only insufficiently. The model has learned incorrect correlations in the data. For example, it may have learned that a simple extrapolation of the past trajectory into the future provides good behavior in a great many cases. This leads to errors, particularly when interacting with other road users or when changes are made in the road topology. The model has not learned to compensate for small errors caused, for example, by latencies in the system, inaccuracies in the control of the vehicle, or external influences, such as crosswind. This leads to an accumulation of errors until the model is no longer able to generate correct behavior. The behavior planning delivered by the learned model is checked with the aid of a downstream module with respect to classically modeled hard constraints and/or boundary conditions for the behavior of the ego vehicle. Due to the different behavior patterns of the modeled constraints and the learned model, this test often leads to an unnecessary degradation of performance.

### SUMMARY

With the disclosure, measures are proposed to reduce the above-mentioned methodological weaknesses of AI-based methods for behavior planning for an autonomous ego vehicle.

According to the disclosure, this is achieved in that, starting from the initial state so in the latent space, a tree structure of state sequences in the latent space is generated by generating at least one subsequent state sᵢ₊₁ of the tree structure for n successive time steps, each starting from a state sᵢ. Such a subsequent state sᵢ₊₁ of the tree structure is generated by first determining, for the state sᵢ, a multimodal behavior policy pᵢ for the ego vehicle and a value (value) vᵢ of the state sᵢ. Then, a behavior option aᵢ is selected from the behavior policy pᵢ, and a reward rᵢ for selecting the behavior option aᵢ in the state sᵢ is determined. The subsequent state sᵢ₊₁ is then generated taking into account the state sᵢ and the selected behavior option aᵢ of the ego vehicle.

Finally, the individual state sequences of the tree structure are evaluated to select a state sequence and to form the basis of the behavior planning. According to the disclosure, the evaluation of the individual state sequences is based on the rewards determined when the tree structure was rolled out.

According to the disclosure, the computing unit of the claimed system for behavior planning is designed to generate, starting from the initial state so in the latent space, a tree structure of state sequences in the latent space by generating at least one subsequent state sᵢ₊₁ of the tree structure for n successive time steps, each starting from a state sᵢ. using a multimodal planning model P and a transition model T. The multimodal planning model P is configured to determine a multimodal behavior policy pᵢ for the ego vehicle in a state sᵢ from which the computing unit selects a behavior option aᵢ, The transition model T is configured to generate a subsequent state sᵢ₊₁, taking into account the state sᵢ and the selected behavior option aᵢ of the ego vehicle in the state sᵢ. The computing unit is further adapted to evaluate the state sequences of the tree structure using a value model V and a reward model R to select a state sequence and use it as the basis for behavior planning; The value model is configured to determine a value (value) vᵢ of the state sᵢ, and the reward model R is configured to determine a reward rᵢ for selecting the behavior option aᵢ in the state sᵢ.

Correspondingly, according to the disclosure, it is proposed to take into account and evaluate the multimodal development of a given traffic scene in the form of a tree structure in latent space, taking into account different behavioral options of the ego vehicle. According to the disclosure, several learned models are used to recurrently roll out the tree structure as well as to evaluate the individual state sequences of the tree structure, namely a planning model, a value model, a transition model and a reward model. For behavior planning, the ratings thus determined for the individual state sequences are interpreted as indirect ratings of the underlying behavior options of the ego vehicle.

In principle, as part of the method according to the disclosure, any multimodal behavior policy pᵢ can be determined for the behavior of the ego vehicle in the state sᵢ. This could be a continuous distribution pᵢ of behavioral options.

However, for rolling out the tree structure, it is beneficial to determine the behavior policy pᵢ using a learned multimodal planning model P, which provides a countable number of discrete behavior options for the ego vehicle for a state sᵢ, along with a score for the individual behavior options. For example, the discrete behavior options may be a countable number of trajectory sections, each of which may be presented in the form of a sequence of path/time points, with further information on the movement state of the ego vehicle at the individual path/time points, if appropriate.

The value vᵢ of the state sᵢ is determined using a value model V which, in a preferred embodiment of the disclosure, has learned to evaluate a state sᵢ based on the possible state sequences resulting therefrom. For example, the assessment criteria used in the training of the value model V to label the training data represent boundary conditions for the validity of a state and are advantageously provided via a rule-based boundary condition model. Such boundary conditions could be, for example, “the ego vehicle must not be off-road” or “avoid collisions of any kind”. The value model V therefore evaluates a state sᵢ not only in view of whether certain boundary conditions are fulfilled in the state sᵢ itself, but also to what extent these boundary conditions are met in possible subsequent states of the state sᵢ. The evaluation of the subsequent states is based on the behavior policy learned. That is to say, the value model V evaluates the subsequent states on the assumption that the learned behavior policy is also used for the behavior of the ego vehicle in the future.

As already mentioned, the method according to the disclosure provides for selecting a behavior option aᵢ from the multimodal behavior policy pᵢ determined for a state sᵢ. In principle, this selection could be made in any way. Thus, it is contemplated to randomly draw a behavior option aᵢ from the distribution of the behavior policy pᵢ, which is referred to as sampling. However, with behavior planning in mind, it proves useful to choose the most likely behavior option. Therefore, in the event that the behavior policy pᵢ is determined in the form of a countable number of discrete behavior options along with a score for each behavior option in the state sᵢ, the scores of each behavior option will be considered when selecting a behavior option aᵢ. Alternatively or in addition to this, the values vᵢ₊₁ of possible subsequent states sᵢ₊₁ of the state sᵢ can also be considered, which result from the implementation of different behavioral options for the state sᵢ.

It is of particular advantage, when selecting a behavior option aᵢ from the behavior policy pᵢ, to check compliance with at least one predetermined boundary condition for the behavior of the ego vehicle in the state sᵢ. Advantageously, these boundary conditions are provided via the same model for rule-based boundary conditions, which is also used in the training of the value model V. This can ensure consistency of the boundary conditions to be considered in overall behavior planning.

Accordingly, in an advantageous embodiment of the disclosure, the computing unit of the claimed behavior planning system has access to at least one model for rule-based boundary conditions. This model describes boundary conditions for the behavior of the ego vehicle in a given traffic situation, so that the computing unit can check and consider such boundary conditions when selecting a behavior option aᵢ from a behavior policy pᵢ determined by the planning model P.

The aim of considering the selection criteria scores, value vᵢ and compliance with boundary conditions when selecting a behavior option aᵢ from a behavior policy pᵢ is to create a tree structure in the latent space, the branches of which map behaviors that maximize the output value of the value model V and/or the planning model P over the entire behavior.

Checking boundary conditions for the behavior of the ego vehicle when selecting a behavior option aᵢ for a state sᵢ can also be used to discard invalid state sequences s₁, . . . , sᵢ of the tree structure. Thus, in an advantageous embodiment of the disclosure, already generated state sequences s₁, . . . , sᵢ are removed from the tree structure when no behavior option aᵢ of a predetermined selection of behavior options aᵢ of the behavior policy pᵢ leads to a valid subsequent state sᵢ₊₁, i.e. a subsequent state sᵢ₊₁, which satisfies at least one predetermined boundary condition. The checks required for this are carried out at the subsequent states sᵢ₊₁. That is to say, first, using the behavior policy pᵢ, the k best behavior options aᵢ are selected. These behavior options aᵢ are then rolled out, resulting in k subsequent states sᵢ₊₁. Then, for each of these k subsequent states sᵢ₊₁ it is checked whether the boundary conditions are satisfied. Only if this is the case is the corresponding subsequent state sᵢ₊₁ and thus the underlying behavior option aᵢ valid.

Thus, a type of back-propagation of the results of the check of boundary conditions (hard-constraint checks) is performed here. This proves to be particularly useful if a branch of the tree structure or the corresponding state sequences are still valid at the beginning, but all later branches lead to invalid states. In this case, the information of the invalid subsequent states is reverse-propagated so that the valid beginning of the later becoming invalid branches of the tree structure can also be removed. This can significantly reduce the computational effort involved in selecting a state sequence of the tree structure for behavior planning. In addition, it is ensured that the remaining tree meets the safety-relevant boundary conditions.

The reward rᵢ of the selection of the behavior option aᵢ for the state sᵢ is determined using a reward model R, which in a preferred embodiment of the disclosure has learned boundary conditions for the behavior of the ego vehicle in the state sᵢ. Advantageously, the same boundary conditions are involved or at least a subset of the boundary conditions that have already been considered in the training of the value model V and are checked in the selection of the behavior option aᵢ.

As already mentioned, the state sequences of the tree structure are evaluated based on the determined rewards r and/or values v to select a state sequence and to use it as a basis for behavior planning. In a preferred variant of the disclosure, the evaluation of the individual state sequences s₁, . . . , sₙ of the tree structure is performed in each case based on the value vₙ of the last state sₙ of the state sequence s₁, . . . , sₙ and/or based on the prices r₀, . . . , rₙ₋₁, wherein a price rᵢ is taken into account in the evaluation of all those state sequences of the tree structure that include the subsequent state s_{i+1.}

The quality of the behavioral planning according to the disclosure and the performance of the claimed system largely depend on the training of the models used—planning model P, value model V, transition model T and reward model. Therefore, the training method for the claimed behavior planning system constitutes a substantial aspect of the disclosure.

According to the disclosure, the claimed training method comprises two training steps.

In a first training step, an imitation learning method is used to train the multimodal planning model P and the transition model T together. In the first training step, the planning model P learns to determine a multimodal behavior policy pᵢ for the ego vehicle in a state sᵢ. Parallel to this, transition model T learns to generate a subsequent state sᵢ₊₁ taking into account the state sᵢ and a behavioral option aᵢ selected from the behavior policy pᵢ.

In a second training step, a closed-loop training method is used to train the planning model P and the transition model T, which were pre-trained in the first training step, as well as the value model V and the reward model R together. In so doing, value model V learns to evaluate a state sᵢ based on the possible state sequences that result from it, and reward model R learns to determine a reward rᵢ for selecting a behavior option aᵢ in a state sᵢ, taking into account boundary conditions for the behavior of the ego vehicle in the state sᵢ.

In the first training step and also in the second training step, preferably scenario-specific information is used as training data, from which latent state data is derived as input data for the planning model P, the transition model T, the value model V and the reward model R. The ground-truth data are also derived from this scenario-specific information.

In both the first and second training steps, a state sequence in the latent space is generated for n consecutive time steps using the planning model P and the transition model T to be trained. The planning model P and transition model T are then modified based on a comparison between the multimodal behavior policy pₙ determined in time step n and a distribution of behavior options determined from the training data as ground truth.

Preferred variants of the training method according to the disclosure are characterized by a regularization of the latent space.

In a first method variant, in at least one time step i, the achieved state sᵢ is compared with a latent state sᵢ derived from the training data for this time step i. The planning model P and the transition model T are then modified based on this comparison.

The regularization of the latent space is carried out here on the basis of a comparison between latent states sᵢ and šᵢ, which map the same timepoint, but were achieved via a different number of passes of the transition model. The result of this comparison is used as a loss function during training.

In a second method variant, to regulate the latent space in at least one time step i, selected scenario-specific information is reconstructed from the achieved state sᵢ and compared to corresponding scenario-specific information derived from the training data for that time step i. The planning model P and the transition model T are then modified based on this comparison.

The regulation of the latent space is carried out here by decoding an attained state sᵢ into an interpretable representation of the environment, such as, for example, drivable area, and a comparison of this representation with an actual representation of the environment stored in the training data or that can be generated from the training data.

In the first training step of the claimed training method, i.e. to pre-train the planning model P and the transition model T by imitation learning, real-world data are preferably used as training data, i.e. data recorded from vehicles controlled by an expert driver in the real world. Accordingly, real-world data covers only a few and only a certain selection of critical situations.

The training data for the second training step are provided with assessment labels that advantageously assess compliance with boundary conditions for the behavior of the ego vehicle. These rating labels are then preferably used for both the training of the value model V and the training of the reward model R.

In the second training step as well, real-world data are typically used as training data. However, the training data for the second training step are advantageously supplemented by data sets that describe simulated possible developments of a given traffic scene and were generated using the pre-trained planning model P and the pre-trained transition model T. This supplements the training data with situations that would be very unlikely to occur with an expert driver in the real world.

Finally, it is noted that the backbone network of the system according to the disclosure can be trained independently of the remaining models, but that it may also be useful to train the backbone network at least in one of the training steps together with the planning model P, the transition model T and/or the value model V and the reward model R.

### BRIEF DESCRIPTION OF THE DRAWINGS

Exemplary embodiments and advantageous further developments of the disclosure are explained in more detail in the following in conjunction with the figures.

FIG. 1 illustrates the cooperation and functions of the individual components of a computer-implemented system according to the disclosure for behavior planning and thus also illustrates the method for behavior planning according to the disclosure for an ego vehicle in a traffic scene.

FIG. 2 illustrates the first training step of the training method according to the disclosure.

FIG. 3 illustrates the second training step of the training method according to the disclosure.

### DETAILED DESCRIPTION

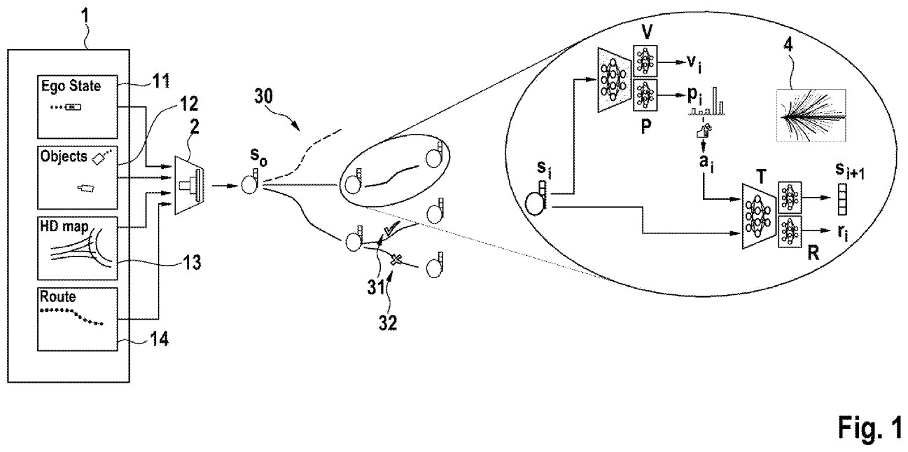

In FIG. 1, a computer-implemented behavior planning system for an ego vehicle is shown in a traffic scene. The system comprises a perception level 1 for capturing the actual state of a traffic scene in the form of scene-specific information aggregated from a plurality of different sources of information. In the exemplary embodiment shown herein, ego information 11 on the state of the ego vehicle, object information 12 on objects and other participants in the traffic scene, map information 13 and route information 14 are aggregated to describe the current state of the traffic scene. This information 11, 12, 13 and 14 is transformed into a latent space using a backbone network 2, which corresponds to a mapping of the captured current state to an initial state so in the latent space. Furthermore, the system comprises a computing unit that performs the individual steps of the behavior planning according to the disclosure starting from an initial state so in the latent space, which is shown in the right half of FIG. 1.

The computing unit generates a tree structure 30 of state sequences in latent space from the initial state so. To this end, at least one successive state sᵢ₊₁ of the tree structure is generated for n successive time steps, each starting from a state sᵢ. This is shown by way of example for a subsequent state sᵢ₊₁ in the right half of the image of FIG. 1. According to the disclosure, a multimodal behavior policy pᵢ for the ego vehicle in the state sᵢ is first determined with the aid of a multimodal planning model P. In the exemplary embodiment shown herein, the planning model P as the behavior policy pᵢ provides a countable number of discrete behavioral options in the form of trajectory sections 4 along with a score for each behavior option. In addition, the state sᵢ is evaluated based on the possible state sequences caused thereby. A correspondingly trained value model V is provided for this purpose, which provides a value (value) vᵢ.

A behavior option aᵢ is selected from the behavior policy pᵢ. In the exemplary embodiment described herein, a behavior option aᵢ is selected that satisfies the following boundary conditions for the behavior of the ego vehicle, which are specified as “hard-constraints”: 1. Freedom from collisions—it must be ensured that the trajectory portion selected as the behavior option aᵢ for the ego vehicle does not result in collisions with static or dynamic objects or other participants of the traffic scene. 2. Exclusion from off-road conditions—it must be ensured that the selected trajectory section is not at any time away from designated traffic paths that are permitted for the ego vehicle.

In this way, it is ensured that no invalid subsequent states and resulting invalid state sequences are generated. This “pruning” of the tree structure 30 is indicated in FIG. 1 by the designation of a valid state transition with a check mark 31 and the designation of an invalid state transition with an X 32.

At this point, it is expressly mentioned once again that even further boundary conditions could be tested, such as compliance with traffic regulations, red traffic lights, etc.

The subsequent state sᵢ₊₁ is then generated using a transition model T, taking into account the state sᵢ and the selected behavior option aᵢ. In parallel, a reward rᵢ for the selection of the behavior option aᵢ in the state sᵢ is determined. For this purpose, a correspondingly trained reward model R is provided, which has learned boundary conditions for the behavior of the ego vehicle in the state sᵢ, and in particular the boundary conditions referred to as “hard-constraints”, which have also been checked when selecting the behavior option aᵢ.

Typically, it is predetermined how many subsequent states sᵢ₊₁ are to be generated from a state sᵢ. Advantageously, the behavior options aᵢ with the highest scores are selected from the behavior policy pᵢ.

The state sequences of the tree structure 30 thus generated are evaluated based on the determined rewards r and/or values v in order to select a state sequence to serve as a basis for behavior planning. In the present exemplary embodiment, the value of a state sequence s₁, . . . , sₙ of the tree structure is calculated in each case based on the rewards r₀, . . . , rₙ₋₁ and based on the value vₙ of the last state sₙ of the state sequence s₁, . . . , sₙ, namely as:

$${\sum }_{i = 0}^{n - 1} {r}_{i} * {w}^{i} + {v}_{n} * {w}^{n}$$

Here, wⁱ are weightings into which the scores of the behavior options underlying the individual states of the state sequence can be incorporated.

In the simplest case, the state sequence with the highest rating is selected for behavior planning. As a result of the behavior planning, the selected behavior options a₀, . . . , aₙ₋₁ are then selected, which are based on the states s₁, . . . , sₙ of the selected state sequence.

FIG. 1 illustrates the concept of behavior planning according to the disclosure for an ego vehicle in a traffic scene. As discussed above, this concept provides for a behavior plan to be recurrently rolled out over several time steps and to assess the achieved states in the latent space. Four learned models are used for this purpose.

1. A planning model P determines, based on a given latent state sᵢ, a discrete distribution pᵢ across all behavior options of a pre-defined behavioral vocabulary. For example, the behavioral vocabulary may be determined by a model-based algorithm, by a learned model, or by mining from a data set. From the distribution pᵢ determined by the planning model P, a behavior option aᵢ is selected as the next action of the ego vehicle. In the present exemplary embodiment, this behavior option aᵢ comprises following a trajectory over a specific period of time, e.g. one second. When selecting the behavior option aᵢ, model-based boundary conditions for the behavior of the ego vehicle are checked.

2. A value model V determines, based on a given latent state sᵢ, the quality of that state sᵢ, wherein the value model V has learned to evaluate a state sᵢ based on the possible state sequences caused thereby.

3. A transition model T calculates a latent subsequent state sᵢ₊₁ of the next time step based on the latent state sᵢ of the previous time step and a selected discrete behavior option aᵢ of the ego vehicle.

4. A reward model R determines, based on the latent state sᵢ of the previous time step and a selected discrete behavioral option aᵢ of the ego vehicle, a reward rᵢ in the form of a scalar rating for selecting the behavioral option aᵢ in the state sᵢ. This reward model R is trained with at least a subset of the model-based boundary conditions in the form of hard boundary functions used herein as loss functions. As a result, the system learns the limits of its range of motion, which, among other things, reduces performance degradation due to the implementation of the hard limits during execution.

For reward model R and value model V, common models from the area of deep learning may be used. For the transformation of the captured current state to an initial state in the latent space, common models may be used to encode a physical state.

It is essential that the stated models P, V, T and R allow a recurrent roll-out and evaluation of the behavior over several time steps. This allows behavior planning with a tree structure, in which multimodality is natively supported by the different branches of the tree and by the discrete distribution of the planning model P. It also allows the method to learn to analyze and evaluate behavioral alternatives.

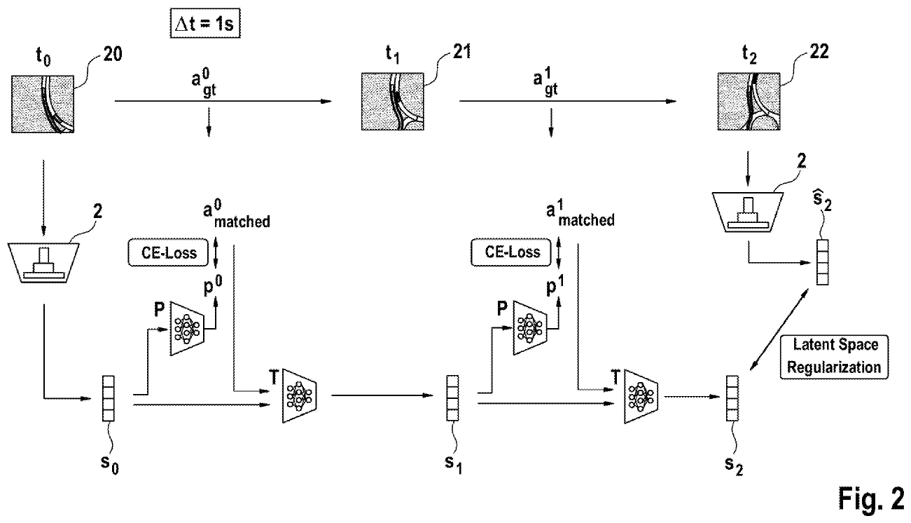

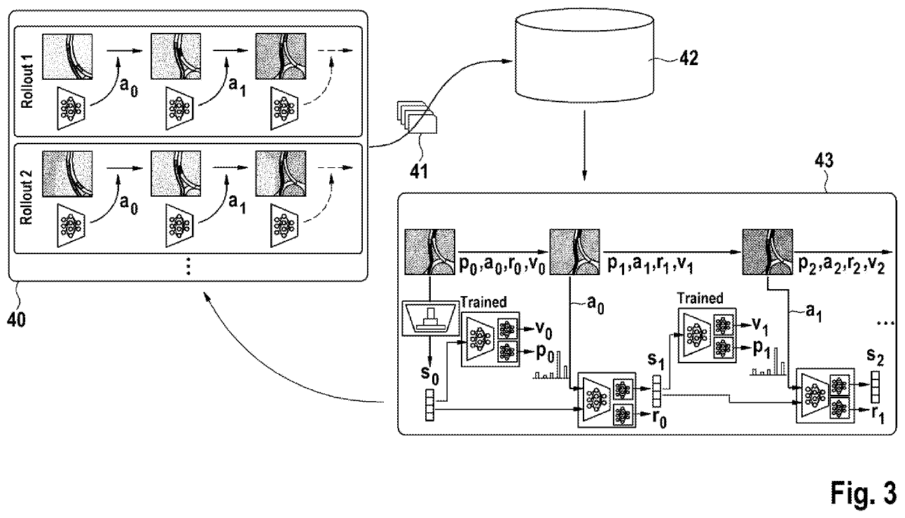

As mentioned previously, the performance of the behavior planning discussed above depends significantly on the training of the P, V, T and R models used. According to the disclosure, a two-step training method is proposed for this purpose, which is explained below on the basis of FIG. 2 and FIG. 3.

In the first training step shown in FIG. 2, the planning model P and the transition model T are pre-trained together. The planning model P is designed to learn to determine a multimodal behavior policy pᵢ for the ego vehicle in a state sᵢ. Parallel to this, the transition model T is intended to learn to generate a subsequent state sᵢ₊₁ taking into account the state sᵢ and a behavioral option aᵢ selected from the behavior policy pᵢ.

According to the disclosure, an imitation learning method is used for this purpose. Real-world training data is used as the training data. In FIG. 2, this training data is shown in the form of snapshots 20, 21, and 22 of a traffic scene taken at intervals of Δt=1 s at successive time points t₀, t₁, and t₂.

With the help of the backbone network 2, the current state of the traffic scene captured in the form of snapshot 20 is mapped to an initial state so in latent space. These initial state data so serve as input data for the planning model P to be trained and the transition model T to be trained. Now, with the help of these models P and T, a state sequence in the latent space is generated for n consecutive time steps. In the exemplary embodiment shown in FIG. 2, this state sequence only comprises three states so, sᵢ, and s₂. For this purpose, the planning model P to be trained provides, based on a state sᵢ, a discrete probability distribution pᵢ for behavior options or actions of a pre-defined behavioral vocabulary. This discrete probability distribution pᵢ is compared to a “one-hot” encoded distribution of the action aⁱ_{gt} from the training data. The “one-hot” encoded vector is derived from the ground truth given by the training data. For this, the corresponding action from the ground-truth is associated with a possible discrete action aⁱ_{gt} of the behavioral vocabulary in a first step. The associated action aⁱ_{gt} is then transferred to a discrete probability distribution with a “one-hot” encoding, i.e. the associated action is given the probability 1.0 and all other actions are given the probability 0.0. As a loss function for the comparison between the discrete probability distribution pᵢ supplied by the planning model P and the “one-hot” encoded distribution of the action aⁱ_{gt} from the training data, a discrete cross-entropy loss function (CE-loss) is used in the exemplary embodiment described herein. The action aⁱ_{gt} is then used to generate a subsequent state sᵢ₊₁ using the transition model T.

After n time steps, the planning model P and the transition model T are modified. The planning model P and the transition model T are then modified based on the sum of the loss functions of the individual time steps.

FIG. 2 also shows that, in at least one time step i, the achieved state sᵢ is compared with a latent state šᵢ derived from the training data for that time step i as ground-truth. In the exemplary embodiment shown herein, the state s₂ is compared to a state š₂ generated by transforming the snapshot 22 at time t₂ into the latent space. Advantageously, for this transformation, the backbone network 2 is also used. However, any other suitable encoder may also be used for this purpose.

The planning model P and the transition model T are then modified based on the comparison between state s₂ and state š₂. This regulation of latent space (latent space regularization) ensures that the tree structure in the latent space corresponds to states in the real world.

Another way to regulate the latent space is that, in at least one time step i, selected scenario-specific information from the achieved state sᵢ is reconstructed and compared to corresponding scenario-specific information derived from the training data for that time step i. To do this, additional models must be integrated that perform reconstruction tasks or decoding of the latent state. Reconstructed information may be, for example, the static or dynamic environment, or particular information important for the driving task, such as the surface to be driven on. The reconstructed information generated in this way is then compared with existing information from the training dataset. A cross-entropy loss function is a suitable loss function.

At this point, it should be noted that the first training step of the training method according to the disclosure in the exemplary embodiment described herein is directed solely to the planning model P and the transition model T. The value model V and the reward model R do not play a role in this and are not affected.

However, it is also possible to pre-train the value model V and the reward model R in the first training step.

FIG. 3 illustrates the second training step of the training method according to the disclosure. Here, a closed-loop training process is used to train the pre-trained planning model P, the pre-trained transition model T, and the value model V and the reward model R together. The value model V is to learn to evaluate a state sᵢ based on the possible state sequences caused by this. Furthermore, the reward model R should learn to determine a reward rᵢ for selecting a behavior option aᵢ in a state sᵢ, taking into account adherence to boundary conditions for the behavior of the ego vehicle in the state sᵢ.

Therefore, the training data for the second training step is provided with assessment labels that evaluate adherence to boundary conditions for the behavior of the ego vehicle. These rating labels include ground-truth information for both the training of value model V and the training of reward model R.

It is essential that the training data for the second training step also include data simulated using the pre-trained planning model P and the pre-trained transition model T in addition to real-world data. The pre-trained planning model P and the pre-trained transition model are used to generate possible developments of a given traffic scene in latent space, which is illustrated by Box 40 in FIG. 3. The current state of a traffic scene is rolled out over several steps in a physical environment by physically executing a selected behavioral option of the ego vehicle in a suitable simulation environment and transitioning the physical state of the previous time step to a physical state of the new time step. This allows the system to learn the consequences of past decisions and explore different behavioral options even in the physical environment. It also synthesizes critical situations that are underrepresented or not found in real-world training data.

The state data 41 thus generated is provided with assessment labels and placed in a replay buffer 42 for the training data of the second training step.

The training data collected in the replay buffer is then used to train all four models P, T, V and R, which is shown in Box 43. The procedure in the second training step differs from that in the first training step—see FIG. 2—only in that the training data also comprises ground-truth information v and r for the training of the value model V and the reward model R. Thus these models V and R are now trained, while the planning model P and transition model T are retrained with the training data of the replay buffers.

The closed loop training process leads to good results for the

value model V and the reward model R, since both a rating of the favored and also the non-favored states can be learned. In order to avoid degradation of performance with the model-based, hard limits during execution, the same boundary conditions are already utilized during training to train the reward model R and the value model V. As a result, the method learns these boundary conditions and can already find exploratory behavior during training that avoids a violation of these boundary conditions. The loss functions of the imitation learning in the first training step now require additional loss functions for the reward model R and the value model V, which compare the output of the respective models R and V with the model-based boundary conditions. Common evaluations for this purpose include collision detection, detection of driving on drivable surfaces (off-road), compliance with traffic rules and speed limits as well as progress (progress). Common L2 loss functions are used for this purpose, for example.

The above-described training method achieves that, in the execution of the inventive method for the behavior planning of an ego vehicle, multiple behavior options in a tree structure are rolled out and evaluated. The behavior options with the highest scores provided by the planning model P are selected and rolled out further. In addition, behaviors that violate predetermined model-based boundary conditions are discarded. These model-based boundary conditions are known to the value model V and the reward model R, respectively, so that behavioral options that comply with these boundary conditions are assigned a higher value. This enables safety guarantees to be maintained with as little degradation of performance as possible.

What is claimed is:

1. A method for behavior planning for an at least partially automated ego vehicle in a traffic scene, in which a current state of the traffic scene is captured and mapped to an initial state in a latent space, the method comprising:
starting from the initial state, a tree structure of a plurality of state sequences in the latent space is generated by generating at least one subsequent state of the tree structure for n successive time steps, each starting from a starting state that the at least one subsequent state of the tree structure is generated;
determining, for the starting state, a multimodal behavior policy for the ego vehicle and a starting value of the starting state;
selecting a selected behavior option from the multimodal behavior policy and determining a reward for selecting the selected behavior option in the starting state;
generating the at least one subsequent state based on the starting state and the selected behavior option; and
evaluating the plurality of state sequences of the tree structure based on the reward and/or the initial value to select a selected state sequence of the plurality of state sequences and to form a basis of the behavior planning.

2. The method according to claim 1, wherein:
the multimodal behavior policy is determined using a learned multimodal planning model, and
the learned multimodal planning model provides a countable number of discrete behavior options along with a score for individual behavior options of the countable number of discrete behavior options in the starting state.

3. The method according to claim 1, wherein the starting value of the starting state is determined using a value model that has learned to evaluate the starting state based on possible state sequences of the plurality of state sequences caused thereby.

4. The method according to claim 2, wherein the selected behavior option from the multimodal behavior policy is selected based on (i) a corresponding score of the countable number of discrete behavior options of the multimodal behavior policy in the starting state and/or (ii) at least one subsequent value of the at least one subsequent state.

5. The method according to claim 2, wherein selecting the selected behavior option from the multimodal behavior policy, includes checking for adherence to at least one predetermined boundary condition for a behavior of the ego vehicle in the starting state.

6. The method according to claim 5, wherein a removed state sequence of the plurality of state sequences is removed from the tree structure when no behavior option of the countable number of discrete behavior options from the multimodal behavior policy leads to a subsequent state that satisfies the at least one predetermined boundary condition.

7. The method according to claim 1, wherein:
the reward is determined using a reward model, and
the reward model has learned boundary conditions for a behavior of the ego vehicle in the starting state.

8. The method according to claim 1, wherein:
the evaluation of individual state sequences of the plurality of state sequences of the tree structure is performed based on a last value of a last state of the plurality of state sequence and/or the reward, and
the reward is taken into account in the evaluation of all the state sequences of the plurality of state sequences of the tree structure that include the at least one subsequent state.

9. A system for behavior planning for an at least partially automated ego vehicle in a traffic scene, the system comprising:
a controller configured to implement the method of claim 1,
wherein, according to a perception level, the controller is configured to capture a captured actual state of the traffic scene,
wherein a backbone network operably connected to the controller is configured to map the captured actual state to the initial state in the latent space,
wherein the controller is configured to (i) generate the tree structure using a multimodal planning model and a transition model, and (ii) evaluate the plurality of state sequences of the tree structure using a value model and a reward model to select the selected state sequence,
wherein the multimodal planning model is configured to determine the multimodal behavior policy for the ego vehicle in the starting state from which the controller selects the selected behavior option,
wherein the value model is configured to determine the starting value of the starting state,
wherein the transition model is configured to generate the at least one subsequent state based on the starting state and the selected behavior option of the ego vehicle in the starting state, and
wherein the reward model is configured to determine the reward for selecting the selected behavior option in the starting state.

10. The system according to claim 9, wherein:
the controller has access to at least one boundary condition model for rule-based boundary conditions,
the rule-based boundary conditions describe boundary conditions for a behavior of the ego vehicle in a given traffic situation, and
the controller selects the selected behavior option from the multimodal behavior policy determined by the multimodal planning model based on the rule-based boundary conditions.

11. A method for training the system according to claim 9, the method comprising:
in a first training step, an imitation learning method is used to pre-train the multimodal planning model as a pre-trained planning model and to pre-train the transition model as a pre-trained transition model together, wherein the multimodal planning model learns to determine the multimodal behavior policy for the ego vehicle in the starting state, and wherein the transition model learns to generate the at least one subsequent state based on the starting state and the selected behavior option selected from the multimodal behavior policy; and
in a second training step, a closed loop training process is used to train the pre-trained planning model, the pre-trained transition model, the value model, and the reward model together, wherein the value model learns to evaluate the starting state based on possible state sequences of the plurality of state sequences caused thereby, and wherein the reward model learns to determine the reward for selecting the selected behavior option in the starting state based on boundary conditions for a behavior of the ego vehicle in the starting state.

12. The method according to claim 11, further comprising:
using scene-specific information as training data from which latent state data is derived as input data for the multimodal planning model, the transition model, the value model, the reward model, and ground truth data;
generating a state sequence in the latent space for n consecutive time steps using the multimodal planning model to be trained and the transition model to be trained; and
modifying the multimodal planning model and the transition model based on a comparison between the multimodal behavior policy determined in time step n and a distribution of behavior options determined from the training data as ground truth.

13. The method according to claim 12, further comprising:
in at least one time step, a first comparison includes comparing an attained state with a latent state derived from the training data for the at least one time step; and
modifying the multimodal planning model and the transition model based on the first comparison.

14. The method according to claim 13, further comprising:
in at least one further time step, a second comparison includes comparing selected scene-specific information reconstructed from the attained state with corresponding scene-specific information derived from the training data for the at least one further time step; and
the multimodal planning model and transition model are modified based on the second comparison.

15. The method according to claim 11, wherein real-world data is used as training data in the first training step and in the second training step.

16. The method according to claim 11, wherein:
training data for the second training step is provided with assessment labels that evaluate adherence to boundary conditions for a behavior of the ego vehicle, and
the assessment labels are used for the training of the value model and/or the reward model.

17. The method according to claim 16, wherein:
possible developments of a given traffic scene are simulated using the pre-trained planning model and the pre-trained transition model to generate state data,
the state data is provided with the assessment labels to form labeled state data, and
the labeled state data is used as training data for the second training step.

18. The method according to claim 11, wherein the backbone network is trained at least in one of the training steps together with the multimodal planning model, the transition model, the value model, and/or the reward model.
